(19) United States
(12) Patent Application Publication
(10) Pub. No.: US 2015/0244096 A1
(43) Pub. Date: Aug. 27, 2015

(54) ELECTRICAL SOCKET WITH IMPROVED MISALIGNMENT TOLERANCE

(71) Applicant: Amphenol Corporation, Wallingford, CT (US)

(72) Inventors: Michael E. UPPLEGER, Cottreville, MI (US); Steven J. FITZGERALD, Export, PA (US)

(21) Appl. No.: 14/192,396

(22) Filed: Feb. 27, 2014

(51) Int. Cl. H01R 13/33; H01R 43/20; H01R 13/11

(52) U.S. Cl. CPC H01R 13/33; H01R 13/111; H01R 43/20

(57) ABSTRACT

A radial socket, including a first a second ring, and conductive contact strips extending between the first and second rings. The conductive contact strips are radially offset at an angle greater than or equal to 50 degrees, providing the radial socket with improved angular and translational misalignment tolerance.

### BACKGROUND

1. Field of the Invention

The present invention relates to electrical connectors. More particularly, the present invention relates to an electrical socket with improved tolerance for angular and translational misalignment.

2. Description of Related Art

Radial sockets, also referred to as barrel terminals, are sockets configured to provide a female electrical connection interface for cylindrical electrical prongs or pins.

FIGS. 1A and 1B are side elevation and end views, respectively, illustrating a related art radial socket 100.

Referring to FIG. 1A, the related art radial socket 100 has a length L₁₀₀ and includes a ring 112, a plurality of contact strips 114, and a ring 116. The contact strips 114 are affixed at one end of the radial socket 100 to the ring 112 and extend longitudinally to the opposite end of the radial socket 100 where they are affixed to the ring 116. A plurality of contact strips 114 are affixed to the rings 112 and 116 in approximately equidistant increments. The juncture between each of the contact strips 114 and the ring 116 is radially offset from the juncture between the corresponding contact strip 114 and the ring 112. As shown in FIG. 1A and FIG. 1B, for example, the juncture 126 formed by the ring 116 and the contact strip 114a is offset by an angle of 30-45 degrees relative to the juncture 122 formed by the ring 112 and the contact strip 114a.

FIG. 1B is an end view of the related art radial socket 100 of FIG. 1A, including the ring 116 and the plurality of contact strips 114. The ring 116 has an interior diameter D₁₁₆. The juncture 126 formed by the contact strip 114a and the ring 116 is radially offset by an angle θ₁₀₀ from the juncture 122 (on the opposite end of the radial socket 100 to the viewer) formed by the contact strip 114a and the ring 112 (see FIG. 1A). As described above, the angular offset θ₁₀₀ of the juncture 126 relative to the juncture 122 causes the radial socket 100 to form a concave shape. The plurality of contact strips 114 provides both a mechanical and electrical connection between the radial socket 100 and an electrical pin receivable therein. As shown in FIG. 1B, the angular offset θ₁₀₀ of related art radial socket 100 is 30-45 degrees. The plurality of contact strips 114 forms an interior diameter D₁₁₄ of the related art radial socket 100.

FIG. 2 is a view illustrating a related art electrical connection system having a female electrical connection device 200 configured to mate with a male electrical connection device 220.

Referring to FIG. 2, the related art female electrical connection device 200 includes a plurality of related art radial sockets 100 rigidly connected to a support structure 210. Each of the radial sockets 100 includes the rings 112 and 116 and the plurality of contacts strips 114. The radial sockets 100 are configured to electrically and mechanically connect with a plurality of pins 222, which are rigidly connected to a support structure 224 to form male electrical connection device 220. When a pin 222 is inserted into a radial socket 100, the plurality of contact strips 114 of the radial socket 100 contacts the pin 222 and expands to accommodate the pin 222, thereby exerting a frictional force on the pin 222 to form and maintain a mechanical and electrical connection therebetween.

The radial sockets 100 are spaced by a distance X₁₀₀ and the pins 222 are spaced by a distance X₂₂₂. Because of the variations in the manufacturing of the female electrical connection device 200 and/or the male electrical connection device 220, one or more of the radial sockets 100 may be translationally misaligned with one or more of the pins 222 causing the distances X₁₀₀ and X₂₂₂, to be unequal. In order to compensate for potential translational misalignment between a radial socket 100 and a corresponding pin 222, the related art electrical connect on system 200 has a translational misalignment tolerance T₁₀₀. In other words, provided each of the pins 222 and radial sockets 100 are aligned within a distance T₁₀₀, the related art female electrical connection device 200 is configured to receive a plurality of pins 222 and form a mechanical and electrical connection between each of the pins 222 and the contact strips 114 of the corresponding radial socket 100. If one of the radial sockets 100 and a corresponding pin 222 are misaligned by a distance greater than T₁₀₀, connecting the male electrical connection device 220 to the related art female connection system 200 may cause damage to either the pin 222 or the corresponding radial socket 100. For example, the pin 222 may make contact with the ring 112 of the corresponding radial socket 100 and damage either the pin 222 or the radial socket 100.

As shown in FIG. 2, the radial sockets 100 are preferably attached to the structure 210 at an angle of 90 degrees relative to the plane of the structure 210. Similarly, the pins 222 are preferably attached to the structure 224 at an angle of 90 degrees. Again, however, one or more of the radial sockets 100 may be angularly misaligned with one or more of the pins 222 because of the variations in the manufacturing of the female electrical connection device 200 and/or the male electrical connection device 220. The related art electrical connection system 200 has an angular misalignment tolerance α₁₀₀, meaning the related art female electrical connection device 200 is configured to receive a plurality of pins 222 and form a mechanical and electrical connection between each oldie pins 222 and the contact strips 114 of the corresponding radial socket 100 if the radial sockets 100 and the pins 222 are aligned within an angle α₁₀₀. An angular misalignment greater than α₁₀₀ may cause similar damage to either the pin 222 or the corresponding radial socket 100 as described above.

Accordingly, there is a need to increase the translational misalignment tolerance T₁₀₀ and/or the angular misalignment tolerance α₁₀₀ of the related art female electrical connection device 200 to avoid damage to the pin 222 and/or radial socket 100.

### SUMMARY OF THE INVENTION

In order to overcome these and other drawbacks of the related art, an electrical connection system is provided.

According to an aspect of an exemplary embodiment, there is provided a female electrical connection device configured to mate with a plurality of electrical pins attached to a male electrical connection device, the female electrical connection device including a support structure a plurality of radial sockets rigidly attached to said support structure, each of the radial sockets including a first ring, a second ring substantially parallel to the first ring, and a plurality of conductive contact strips extending between the first and second rings, each of the plurality of conductive contact strips being attached to the first ring at a first position and attached to the second ring at a second position, the first position being offset from the second position at an angle greater than 50 degrees.

According to another aspect of an exemplary embodiment, there is provided a method of making a female electrical connection device configured to mate with a plurality of electrical pins attached to a male electrical connection device, the method including providing a support structure, providing a plurality of radial sockets, each of the plurality of radial sockets including a first ring, a second ring substantially parallel to the first ring, and a plurality of conductive contact strips extending between the first and second rings, each of the conductive contact strips attached to the first ring at a first position and attached to the second ring at a second position, the first position being offset from the second position at an angle greater than 50 degrees, and attaching the plurality of radial sockets to the structure.

According to another aspect of an exemplary embodiment, there is provided a radial socket including a first ring, a second substantially parallel to said first ring, and a plurality of conductive contact strips extending between the first and second rings, each of the conductive contact strips attached to yje first ring at a first position and attached to the second tin at a second position, the first position being offset from the second position at an angle greater than 50 degrees.

### BRIEF DESCRIPTION OF THE DRAWINGS

Exemplary embodiments will be set forth with reference to the drawings, in which:

FIGS. 1A and 1B are side elevation and end views, respectively, illustrating a related art radial socket;

FIG. 2 is a cross-sectional view of a related art electrical connection system, including a plurality of the related art radial sockets illustrated in FIGS. 1A and 1B;

FIGS. 3A and 3B are side elevation and end views, respectively, illustrating a radial socket according to an exemplary embodiment of the present invention;

FIG. 4 is a cross-sectional view of an electrical connection system according to an exemplary embodiment of the present invention, including a plurality of the radial sockets illustrated in FIGS. 3A and 3B;

FIG. 5 is another cross-sectional view of the electrical connection system illustrated in FIG. 4; and

FIG. 6 is another cross-sectional view of the electrical connection system illustrated in FIG. 4.

### DETAILED DESCRIPTION OF EXEMPLARY EMBODIMENTS

Exemplary embodiments of the present invention will be set forth in detail with reference to the accompanying drawings, in which like reference numerals refer to like elements throughout. Exemplary embodiments illustrated in the accompanying drawings are not necessarily to scale and are instead provided to convey the inventive concepts to one of ordinary skill in the art.

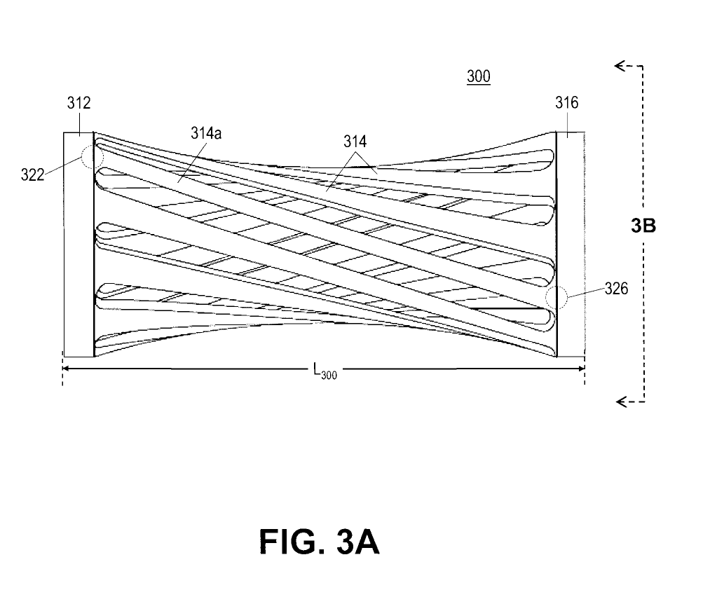

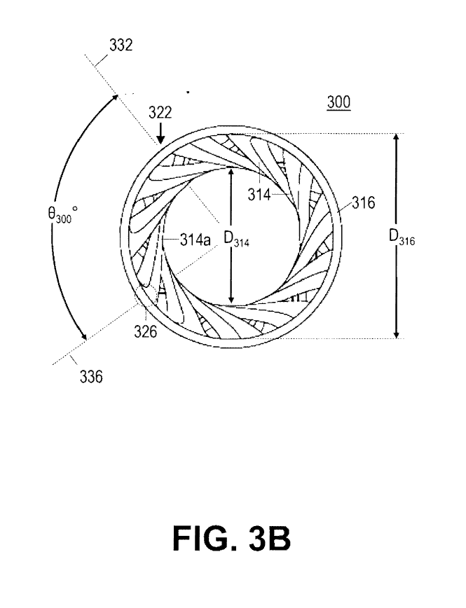

FIGS. 3A and 3B are side elevation and end views, respectively, illustrating a radial socket 300 according to an exemplary embodiment of the present invention.

Referring to FIG. 3A, the radial socket 300 has a length L₃₀₀ and includes a ring 312, a plurality of contact strips 314, and a ring 316. The ring 312 is substantially parallel to the ring 316. The plurality of contact strips 314 are affixed to the rings 312 and 316 in approximately equidistant increments and extend longitudinally between the rings 312 and 316. The contact strips 314 may be any electrically conductive material, including silver, copper, etc., and may be affixed to the rings 312 and 316, for example, by welding. Alternatively, the contact strips 314 and the rings 312 and 316 may be formed from a single piece of conductive material (for example, by stamping) and bent to form the radial socket 300.

The junctures between the ring 316 and each of the contract strips 314 are radially offset from the corresponding junctures between the ring 312 and each of the contact strips 314 causing the radial socket 300 to form a tapered shape. Unlike the related art radial socket 100, the corresponding junctures of the radial socket 300 are preferably offset by an angle greater than or equal to 50 degrees. As shown in FIG. 3A, for example, the juncture 326 formed by the ring 316 and the contact strip 314a is offset by an angle that is preferably greater than or equal to 50 degrees relative to the juncture 322 formed by the ring 312 and the contact strip 314a. The increased angular offset causes the length L₃₀₀ of the radial socket 300 to be shorter than the length L₁₀₀ of the related art radial socket 100, if all other dimensions of the radial sockets 300 and 100 are equal. The increased angular offset increases the tapered shape of the radial socket 300 relative to the related art radial socket 100.

FIG. 3B is an end view of the radial socket 300 of FIG. 3A, including the ring 316 and the plurality of contact strips 314.

Referring to FIG. 3B, the ring 316 has an interior diameter D₃₁₆. The juncture 326 formed by the contact strip 314a and the ring 316 is radially offset by an angle θ₃₀₀ from the juncture 312 (on the opposite end of the radial socket 300) formed by the contact strip 314a and the ring 312 (see FIG. 3A). As shown in FIG. 3B, the angular offset θ₃₀₀ of the radial socket 300 is preferably greater than or equal to 50 degrees causing the plurality of contact strips 314 to form an interior diameter D₃₁₄ of the radial socket 300.

The angular offset θ₃₀₀ may be measured, for example, as follows. The center of the ring 316 and the center of the ring 312 form a longitudinal center axis through the center of the radial socket 300. The center axis and the juncture 326 form a line 336 substantially parallel to the plane of the ring 316. The center axis and the juncture 322 form a line 332 substantially parallel to the plane of the ring 312. As shown in FIG. 3B, the angle θ₃₀₀ is the difference between the line 332 and the line 336 measured along the plane substantially parallel to the rings 312 and 316.

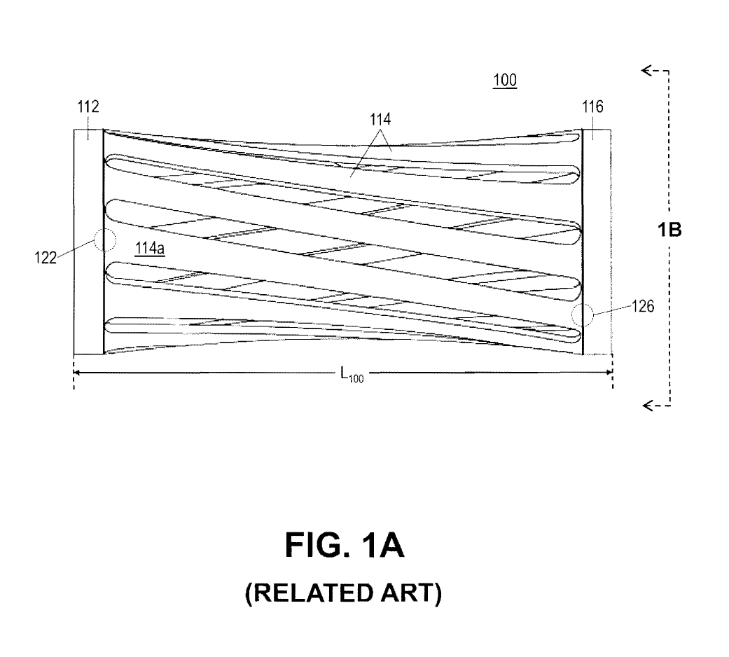

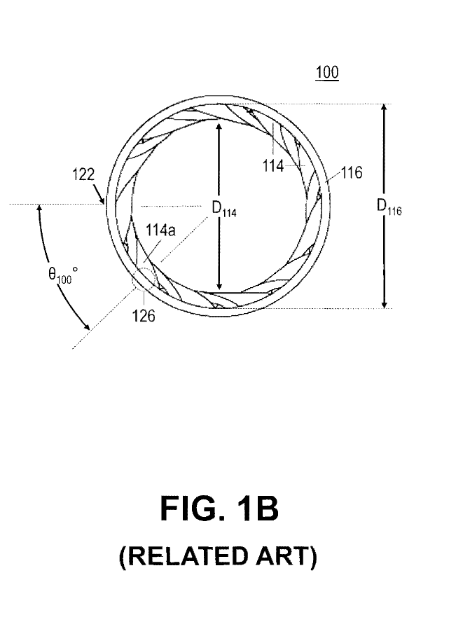

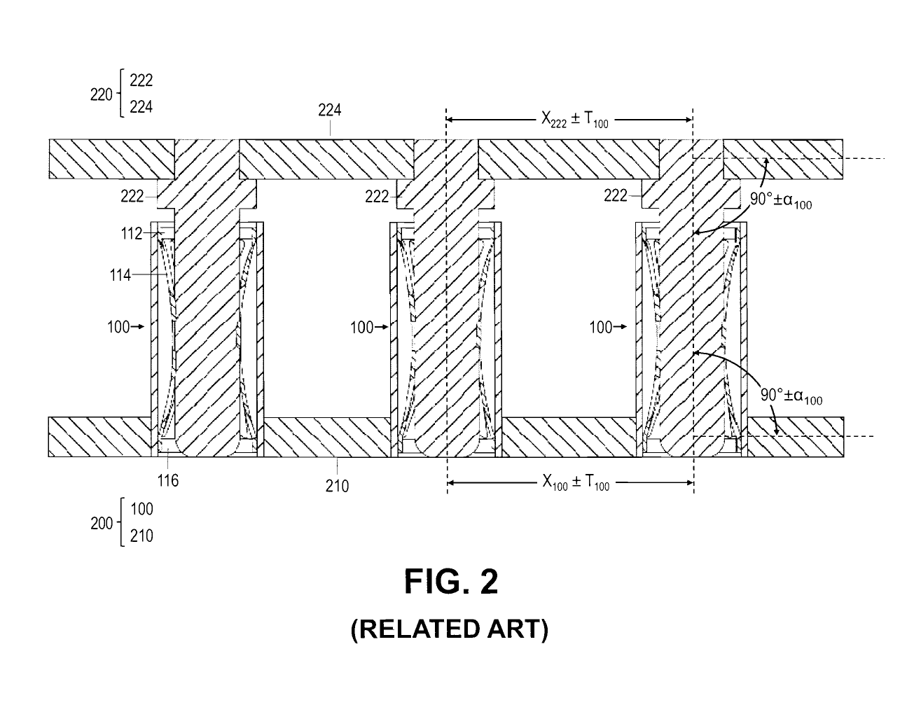

As shown in FIGS. 1B and 3B, the diameter D₃₁₄ relative to the diameter D₃₁₆ of the radial socket 300 is smaller than the diameter D₁₁₄ relative to the diameter D₁₁₆ of the related art radial socket 100. In other words, the difference between the diameters D₃₁₆ and D₃₁₄ of the radial socket 300 is greater than the difference between the diameters D₁₁₆ and D₁₁₄ of the related art radial socket 100.

In some exemplary embodiments, the rings 312 and 316 of the radial socket 300 may have diameters D₃₁₂ and D₃₁₆ that are equal to the diameters D₁₁₂ and D₁₁₆ of the related art radial socket 100. In these exemplary embodiments, the angular offset θ₃₀₀ causes the diameter D₃₁₄ of the plurality of contact strips 314 to be smaller than the diameter D₁₁₄ of the related art radial socket 100. The smaller diameter D₃₁₄ increases the frictional force exerted on a pin 222 and creates a stronger and more persistent mechanical and electrical connection between the radial socket 300 and the pin 222.

More preferably, however, the diameters D₃₁₂ and D₃₁₆ of the rings 312 and 316 may be larger than the diameters D₁₁₂ and D₁₁₆ of the rings 112 and 116 of the related art radial socket 100. In these exemplary embodiments, the angular offset θ₃₀₀ causes the diameter D₃₁₄ of the plurality of contact strips 314 to be approximately equal to the diameter D₁₁₄ of the related art radial socket 100 despite the larger size of the ring 316 relative to the ring 116. As described below, the increase in diameter D₃₁₆ of the ring 316 (relative to the diameter D₁₁₆ of the ring 116) increases the translational and angular tolerance of the radial socket 300 while the approximately equal diameter D₃₁₄ of the contact strips 314 (relative to the diameter D₁₁₄ of the contact strips 116) allows the radial socket 300 to maintain a mechanical and electrical connection between the radial socket 300 and the pin 222.

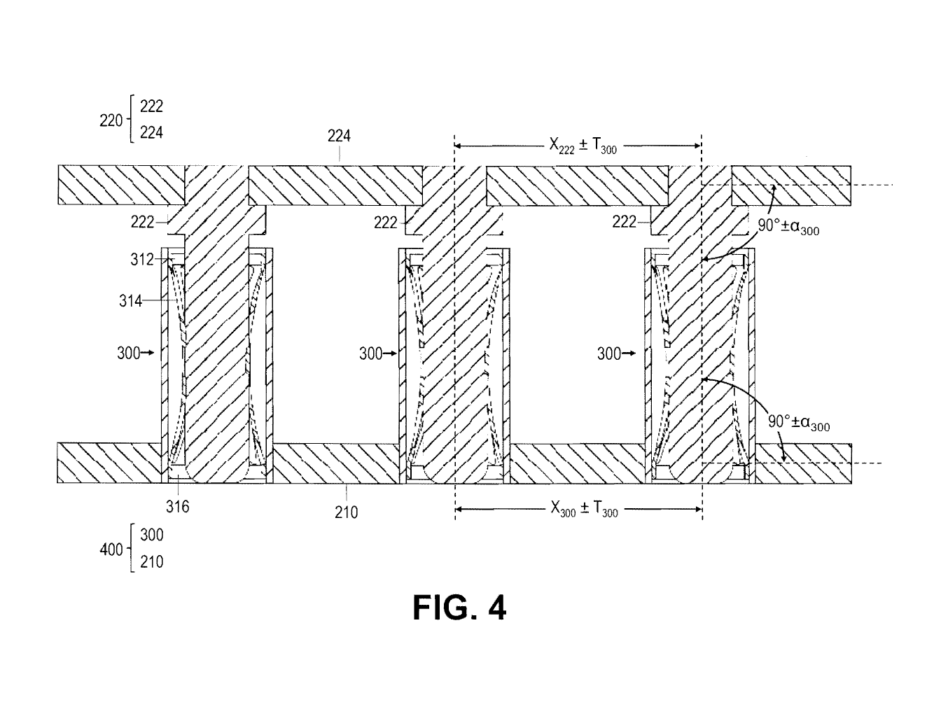

FIG. 4 is a cross-sectional view of an electrical connection system including a female electrical connection device 400 configured to mate with the male electrical connection device 220 according to an exemplary embodiment of the present invention.

Referring to FIG. 4, the female electrical connection device 400 includes a plurality of radial sockets 300 rigidly connected to the structure 210. Each of the radial sockets 300 includes the rings 312 and 316 and the plurality of contacts strips 314 therebetween. The radial sockets 300 are configured to electrically and mechanically connect with the plurality of pins 222, which are rigidly connected to the structure 224 of the male electrical connection device 220. The structure 210 and the structure 224 may be any suitable electrical and mechanical device, such as a bus bar, a server, a server rack, etc. In order to accommodate the pins 222, the diameters D₃₁₂ and D₃₁₆ of the rings 312 and 316 are greater than the diameter of each pin 222. The contact strips 314 form a flexible mesh with a diameter D₃₁₄ that is less than the diameter of each pin 222. When a pin 222 is inserted into a radial socket 300, the plurality of contact strips 314 of the radial socket 300 contacts the pin 222 and expands to accommodate the pin 222, thereby exerting a frictional force on the pin 222 to form and maintain a mechanical and electrical connection therebetween. Accordingly, a mechanical connection is formed between the structures 210 and 224 and an electrical connection is formed from the structure 210 through the plurality of contacts strips 314 and the pins 222 to the structure 224.

The radial sockets 300 are spaced by a distance X₃₀₀ and the pins 222 are spaced by a distance X₂₂₂. In order to compensate for potential translational misalignment between a radial socket 300 and a corresponding pin 222, the female electrical connection device 400 has a translational misalignment tolerance T₃₀₀. In other words, the female electrical connection device 400 is configured to receive the plurality of pins 222 and form a mechanical and electrical connection between each of the pins 222 and the contact strips 314 of the corresponding radial sockets 300 provided each or the pins 222 and radial sockets 300 are aligned within a distance T₃₀₀.

The radial sockets 300 are preferably attached to the structure 210 at an angle of 90 degrees relative to the plane of the structure 210. Similarly, the pins 222 are preferably attached to the structure 224 at an angle of 90 degrees. In order to compensate for potential angular misalignment between a radial socket 300 and a corresponding pin 222, the female electrical connection device 400 has an angular misalignment tolerance α₃₀₀, meaning the female electrical connection device 400 is configured to receive the plurality of pins 222 and form a mechanical and electrical connection between each of the pins 222 and the contact strips 314 of the corresponding radial sockets 300 if the radial sockets 300 and the pins 222 are aligned within an angle α₃₀₀.

As will be described in more detail below, the increased angular offset θ₃₀₀ of the radial sockets 300 (relative to the angular offset θ₁₀₀ or the related art radial sockets 100) increases both the translational misalignment tolerance T₃₀₀ (relative to the translational misalignment tolerance T₁₀₀ of the related art radial sockets 100) and the angular misalignment tolerance α₃₀₀ of the radial sockets 300 (relative to the angular misalignment tolerance α₁₀₀ of the related art radial sockets 100).

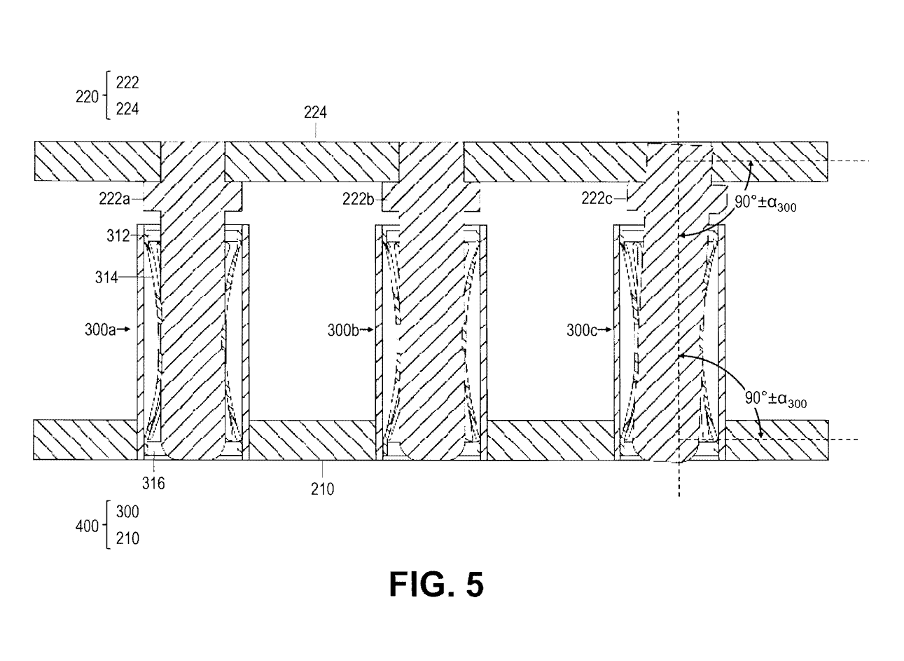

FIG. 5 is another cross-sectional view of the electrical connection system illustrated in FIG. 4.

Referring to FIG. 5, the pin 222c is angularly misaligned relative to the radial socket 300c. Because the pin 222c is angularly misaligned at an angle greater than the angular misalignment tolerance α₁₀₀ of the related art radial sockets 100, connecting the male electrical connection device 220 to the related art female connection system 200 would likely cause damage to either the pin 222c or the corresponding radial socket 100.

As shown in FIG. 5, however, because the diameter D₃₁₂ (see FIG. 3B) of the ring 312 is greater than the diameter D₁₁₂ of the ring 112, the pin 222c is able to enter the radial socket 300c and form an electrical and mechanical connection with the contact strips 314 of the radial socket 300c without damaging either the pin 222c or the radial socket 300c. Furthermore, the increased angular offset θ₃₀₀ of the radial sockets 300 (relative to the angular offset θ₁₀₀ of the related art radial sockets 100) of at least 50 degrees increases the frictional fit between the radial sockets 300 and the pins 222 and allows the radial sockets 300a and 300b to maintain a stable electrical and mechanical connection with the pins 222a and 222b, respectively.

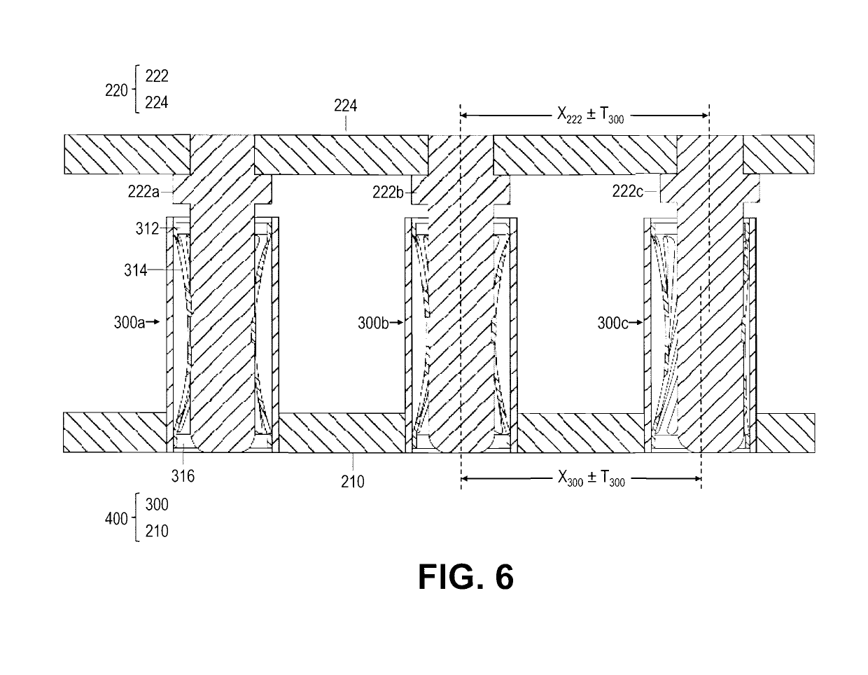

FIG. 6 is another cross-sectional view of the electrical connection system illustrated in FIG. 4.

Referring to FIG. 6, the radial socket 300c is translationally misaligned relative to the pin 222c. Because the radial socket 300c is translationally misaligned greater than the translational misalignment tolerance T₁₀₀ of the related art radial sockets 100, connecting the male electrical connection device 220 to the related art female connection system 200 would likely cause damage to either the pin 222c or the corresponding radial socket 100.

As shown in FIG. 6, however, because the diameter D₃₁₂ of the ring 312 is greater than the diameter D₁₁₂ of the ring 112, the translational misalignment tolerance T₃₀₀ is up to 0.01 inches or greater. Accordingly, the pin 222c is able to enter the radial socket 300c without damaging either the pin 222c or the radial socket 300c. Furthermore, the increased angular offset θ₃₀₀ of the radial sockets 300 (relative to the angular offset θ₁₀₀ of the related art radial sockets 100) of at least 50 degrees increases the frictional tit between the radial sockets 300 and the pins 222 and allows the radial sockets 300a and 300b to maintain a stable electrical and mechanical connection with the pins 222a and 222b, respectively.

While exemplary embodiments have been set forth above, those skilled in the art who have reviewed the present disclosure will readily appreciate that other embodiments can be realized within the scope of the invention. For example, disclosures of specific numbers of radial sockets, conductive strips, and the like are illustrative rather than limiting, as are disclosures of specific materials. Therefore, the present invention should be construed as limited only by the appended claims.

1. A female electrical connection device configured to mate with a plurality of electrical pins attached to a male electrical connection device, said female electrical connection device comprising:
a support structure; and
a plurality of radial sockets attached to said support structure, each of said radial sockets including:
a first ring,
a second ring substantially parallel to said first ring, and
a plurality of conductive contact strips extending between said first and second rings, each of said plurality of conductive contact strips being attached to said first ring at a first position and attached to said second ring at a second position, said first position being offset from said second position at an angle greater than 50 degrees.

2. The connection device of claim 1, wherein:
a center of said first ring and a center of said second ring form a center axis of each radial socket substantially perpendicular to a plane substantially parallel to said first and second rings;
said second position and said center axis form a first line along said plane;
said second position and said center axis form a second line along said plane; and
said first line is offset from said second line by the angle greater than 50 degrees along said plane.

3. The connection device of claim 1, wherein a diameter of said first ring and a diameter of said second ring are greater than a diameter of each of said plurality of electrical pins.

4. The connection device of claim 1, wherein said plurality of conductive contact strips forms a flexible conductive mesh.

5. The connection device of claim 4, wherein said flexible conductive mesh has an inner diameter less than said diameter of said each of said plurality of electrical pins.

6. The connection device of claim 4, wherein said flexible conductive mesh is configured to expand to accommodate a corresponding electrical pin of said plurality of electrical pins and exert a frictional force on said corresponding electrical pin.

7. The connection device of claim 6, wherein said flexible conductive mesh is configured to expand to accommodate said corresponding electrical pin and exert a frictional force on said corresponding electrical pin.

8. The connection device of claim 1, wherein:
said female electrical connection device is electrically connected to a server and said male electrical connection device is electrically connected to a server rack; or
said female electrical connection device is electrically connected to a server rack and said male electrical connection device is electrically connected to a server.

9. A method of making a female electrical connection device configured to mate with a plurality of electrical pins attached to a male electrical connection device, the method comprising:
providing a support structure;
providing a plurality of radial sockets, each of the plurality of radial sockets including a first ring, a second ring substantially parallel to the first ring, and a plurality of conductive contact strips extending between the first and second rings, each of the conductive contact strips attached to the first ring at a first position and attached to the second ring at a second position, the first position being offset from the second position at an angle greater than 50 degrees; and
attaching the plurality of radial sockets to the structure.

10. The method of claim 9, wherein:
a center of the first ring and a center of the second ring form a center axis substantially perpendicular to a plane substantially parallel to the first and second rings;
the second position and the center axis form a first line along the plane;
the second position and the center axis form a second line along the plane;
the first line is offset from the second line by an angle greater than 50 degrees along the plane.

11. The method of claim 9, wherein providing each of the plurality of radial sockets comprises:
providing the first ring;
providing the second ring;
welding the plurality of conductive contact strips to the first and second rings.

12. The method of claim 9, wherein providing each of the plurality of radial sockets comprises:
providing a piece of conductive metal; and
bending the piece of conductive metal into the first ring, the second ring, and the plurality of conductive contact strips.

13. The method of claim 12, wherein providing the piece of conductive metal comprises:
providing a conductive blank; and
stamping the conductive blank to form the piece of conductive metal.

14. The method of claim 9, wherein each of the plurality of conductive contact strips forms a flexible conductive mesh.

15. The method of claim 14, wherein the flexible conductive mesh has an inner diameter less than the diameter of the each of the plurality of electrical pins.

16. The method of claim 4, wherein the flexible conductive mesh is configured to expand to accommodate a corresponding electrical pin of the plurality of electrical pins and exert a frictional force on the corresponding electrical pin.

17. The method of claim 16, wherein the flexible conductive mesh is configured to expand to accommodate the corresponding electrical pin and exert a frictional force on the corresponding electrical pin.

18. The method of claim 9, further comprising:
electrically connecting the female electrical connection device is to a server and electrically connecting the male electrical connection device to a server rack; or
electrically connecting the female electrical connection device is to a server rack and electrically connecting the male electrical connection device to a server.

19. A radial socket comprising:
a first ring;
a second ring substantially parallel to said first ring; and
a plurality of conductive contact strips extending between said first and second rings, each of said conductive contact strips attached to said first ring at a first position and attached to said second ring at a second position, said first position being offset from said second position at an angle greater than 50 degrees.

20. The socket of claim 19, wherein:
a center of said first ring and a center of said second ring form a center axis substantially perpendicular to a plane substantially parallel to said first and second rings;
said second position and said center axis form a first line along said plane;
said second position and said center axis form a second line along said plane;
said first line is offset from said second line by the angle greater than 50 degrees along said plane.
